(19) United States
(12) Patent Application Publication
(10) Pub. No.: US 2009/0265192 A1
(43) Pub. Date: Oct. 22, 2009

(54) Usefulness

(76) Inventor: Susan Beth Mapes, Rockville, MD (US)

Correspondence Address: Susan Mapes, 14247 Briarwood Terrace, Rockville, MD, 20853, US

(21) Appl. No.: 12/148,109

(22) Filed: Apr. 17, 2008

(51) Int. Cl. G06Q 40/00

(52) U.S. Cl. 705/4

(57) ABSTRACT

A novel divorce insurance annuity insurance business structure that demonstrates the use of this type of insurance with or without a divorce occurrence. The divorce insurance business structure is a model plan to allow businesses to develop this type of benefit for their employees or clientele. The business structure provides companies with the general format for divorce annuity insurance and leaves it up to each company to define their own specifications for the insurance.

Divorce insurance provides an economic cushion for an unpredictable life occurrence which impacts the economic viability of individuals. Divorce insurance would broaden the insurance market offering profitable advantages to companies and corporations who structure divorce insurance in the same fashion as the annuity insurance market.

Annuities purchased outside of an IRA or qualified retirement plan would be the investment option. Employees would fund an agreed upon percent of the insurance premium and employers' would fund an agreed upon percent of the insurance premium. Taxes would not be paid on any accrued interest until money is withdrawn from the annuity. Annuities can be placed in individual names or married couples can claim 50/50 ownership with proceeds from the annuity divided equally, if divorce procedures are initiated. Payouts can be made immediately after an account is opened or could be deferred until a later time when one needs the income for divorce reasons. In order to withdraw benefits you do not have to be divorced or separated, you just have to have a divorce attorney describe the pursuit. It is left up to the individual purchasing the divorce annuity or the employees company to determine the amount they will fund annually based on the salary of the employee and company policy. Legal fees, medical claims as a result of the divorce process, and relocation costs of claimants would be covered. Proof of costs associated with the divorce would be supplied to the insurance company in the form of valid receipts. If the benefits are never utilized, the annuities benefits could be passed on to your beneficiaries at your death. This type of insurance will have two economic advantages.

Divorce insurance would be employer based and individuals would be encouraged to fund these plans. Financial counseling would be required by any employer who offered these plans to counsel all new employees and existing employees outlining the advantages in utilizing these divorce annuity insurance plans. Companies who provide these plans would be required to provide records to the insurance companies that demonstrate their efforts in educating their employees about the divorce annuity insurance plans. Referring to FIG. 1.

First of all, divorce insurance will allow both genders the opportunity to have another life long form of indemnification such as life insurance. Divorce insurance justifies making provisions for the uncertainty of the outcome of a marriage. Companies and corporations would be encouraged to offer divorce insurance in the same fashion as medical, life, vision and dental insurance. Car insurance and divorce insurance will be synonymous with sound financial planning. Referring to FIG. 2.

The second economic advantage in offering divorce insurance is the stabilization of the individual or individuals during the reorganization phase of families. The divorce process results in legal and lifestyle financial burdens necessitating the need for indemnification. Evacuating partners or parents create an economic burden that can influence the ability of the individuals or family to reorganize themselves to lifestyle changes. This impacts the work and home environment. Divorce insurance will provide the economic cushion that will give greater probability that the individual or individuals will not be compromised due to the financial pressure that occurs during the reorganization process. Companies and corporations will embrace the added security for their employees and will readily devote some portion of compensation for their employees to participate in a divorce insurance program. The divorce rate statistics prove the risk factor involved for marriages and justifies this approach to the indemnity market.

This patent is unique to the twenty first century and to the indemnity market because it will regulate the divorce process by making fees and expenses associated with divorce competitive and reasonable. This patent requires financial backing from the employee and employer because of the impact to the workplace.

New Approach in an Established Market

Divorce insurance is a new approach in the established indemnity market. It will be considered to be the “New Kid n the Block” or an immerging insurance offspring. Young adults will revolutionize the use of this insurance offering seeing both the necessity due to the failure statistic of marriages and the possibility of divorce, and the complex financial forecast in the immerging half-century. Divorce will no longer be equated to disaster just like car accidents protect one from financial debacle when a wreck occurs. Divorce insurance will help normalize attitudes toward family reorganization providing a new genesis in the insurance market.

Colleges and universities, corporations, and families will promote the early acceptance of apportioning ones income to cover the potential loss due to divorce occurrences. The idea behind insurance is to bring stabilization to catastrophic or stressful and unpredictable life occurrences. There is no doubt that there will be an economic boost to schools, neighborhoods, medical practices, and employers when divorce insurance is accepted and implemented into the mainstream. Referring to FIG. 3.

There will be a strong reverberation of international interests in developing divorce indemnification in the international economic markets. Foreign companies will rapidly mimic the immerging insurance offspring into their own vulnerable financial markets. Plummeting marriages is problematic in all foreign countries, and there will be strong interests to support this new industry.

Unobvious Nature of Divorce Insurance and the Need for Patenting the Idea

Divorce Insurance has remained unobvious in the established insurance market. Web searches produce no viable sources to seek insurance for divorce indemnification from major companies. The patent will bring to the forefront the credibility to develop a new offering to the insurance market. The need for divorce insurance is evident, but employers need the indemnity market to present valid plans to there employees. The patent will serve as a catalyst to ignite universal appeal for the insurance market to provide protection when marriages fail.

Statement of Intentions

Divorce insurance should be established and marketed on a broad scale. By patenting the business marketability of divorce insurance there is hope that insurance companies will give coverage by contract to clients who want to be indemnified and reimbursed for the loss incurred by failed or accidental marriages. The patent will facilitate the foundation for divorce insurance to be commonly purchased at the onset of young adulthood similar to the purchase of life or car insurance when one comes of age.

### BRIEF DESCRIPTIONS OF THE DRAWINGS

FIG. 1 is a schematic diagram illustrating the types of claims made with divorce annuity insurance

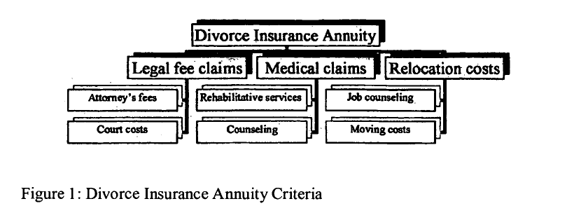

FIG. 2 is a schematic diagram illustrating the business justifications for developing divorce annuity insurance

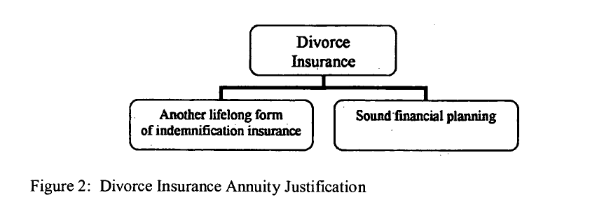

FIG. 3 is a schematic diagram identifying the clientele who will utilize annuity insurance

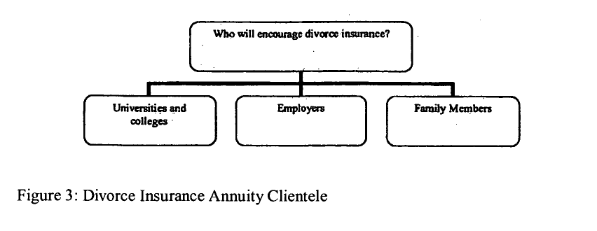

FIG. 4 is a schematic diagram displaying what happens when divorce annuity insurance is purchased and there is no divorce occurrence

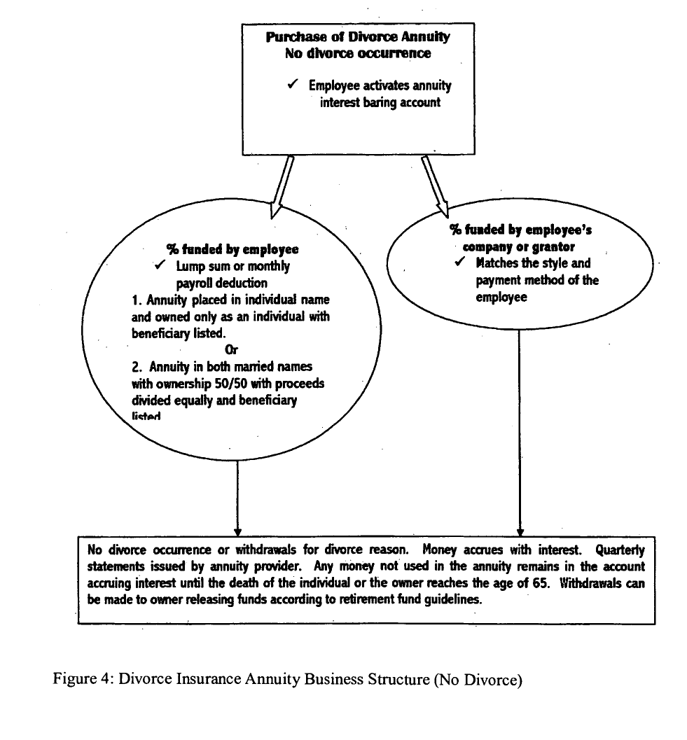

FIG. 5 is a schematic diagram displaying what happens when divorce annuity insurance is purchased and there is a resulting divorce occurrence.

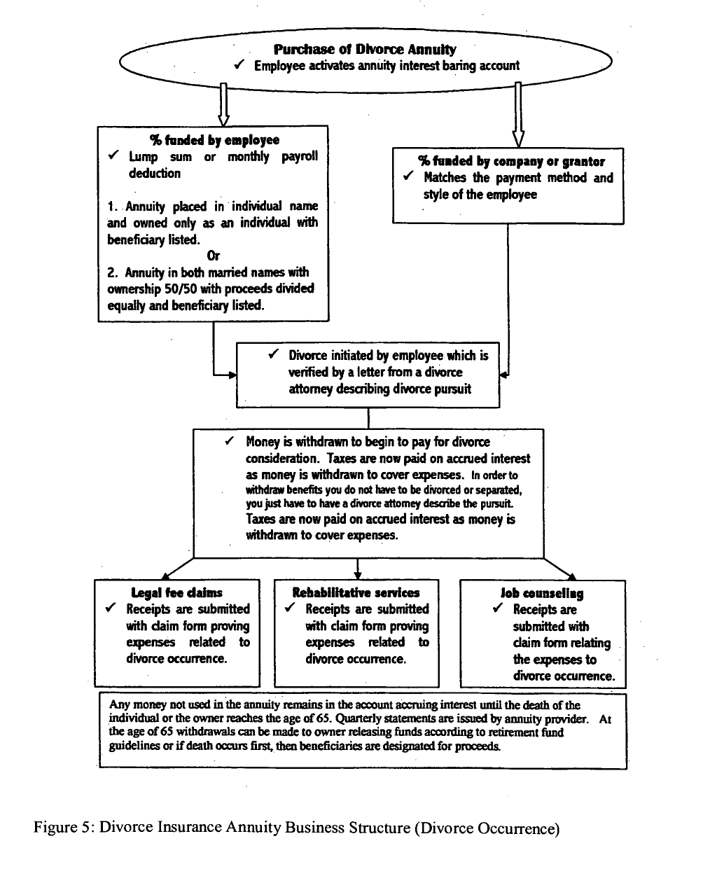

I claim:

1. A method for a business structure that provides annuity divorce insurance for individuals seeking indemnification from financial loss resulting from failed marriages. Searches have proven that this type of business structure does not exist and is necessary to protect individuals and families. This divorce annuity divorce insurance business structure offers another form of insurance that will protect the individual or individuals from financial debacle resulting from a divorce. Companies may elect to contribute whatever percentage they choose from 0-100%, but they are obligated to encourage employees to take part in the insurance plan to protect them.
